(19) United States
(12) Patent Application Publication
(10) Pub. No.: US 2015/0183477 A1
(43) Pub. Date: Jul. 2, 2015

(54) BICYCLE LIGHT SIGNAL DEVICE CAPABLE OF AUTOMATIC ACTIVATION AND LIGHT SIGNAL SYSTEM USING THE SAME

(71) Applicant: Kuo Chi YANG, New Taipei City (TW)

(72) Inventor: Kuo Chi YANG, New Taipei City (TW)

(21) Appl. No.: 14/571,924

(22) Filed: Dec. 16, 2014

(30) Foreign Application Priority Data
Jan. 2, 2014 (TW) 103100040

(51) Int. Cl. B62J 6/00

(52) U.S. Cl. CPC B62J 6/001; B62J 6/005; B62J 2006/006

(57) ABSTRACT

The present invention is to provide a bicycle light signal device capable of automatic activation and including a housing fixed to a bicycle and having a receiving space therein for accommodating a vibration switch, a control module, a light signal module and a switch, wherein the vibration switch is able to generate a vibration signal according to a vibration detection result, the control module is able to enter an operating state from a dormant state in response to the vibration signal, the light signal module is driven by the control module to emit light when the control module is in the operating state, and the switch is able to be switched to send a mode-switching signal to the control module, so as for the control module in the operating state to control the light signal module to generate a light signal according to the corresponding mode-switching signal.

### FIELD OF THE INVENTION

The present invention relates to a bicycle light signal device, more particularly to a bicycle light signal device capable of automatically being activated and generating a desired light signal.

### BACKGROUND OF THE INVENTION

Recent years, bicycle riding has become an important option of recreational activity. As the population of cyclists expands rapidly, the safety of bicycle riding is not to be ignored, especially given the fact that cycling at night is nowadays just as common as during the day. With respect to cycling safety, many bicycle-related companies have invested actively in the research and development of lamps or light signal devices for use on bicycles, with the intention of providing enhanced illuminance to overcome the low visibility and reduced range of view at night and using a specific light source to warn other road users proactively so as to increase the safety of bicycle riders during the night. As more and more people engage in cycling, the aforesaid lamps and light signal devices have come to be indispensable safety equipment in bicycle riding.

Generally, a bicycle light signal device is configured to produce a warning light or a light signal indicating the direction in which the rider wishes to turn, and a dry battery or rechargeable battery is typically used as the power source. A cyclist riding in a low-visibility environment (e.g., at night or in a tunnel) has to operate the switch on such a light signal device manually in order to turn on the system power of the light signal device and thereby enable the device to provide a warning light or turn signal. When the cyclist subsequently rides into a high-visibility environment or gets off the bicycle for a rest, he or she must turn off the light signal device manually to stop its power consumption now that the light signal device is no longer needed for service. However, user experience has shown that not only is the aforesaid manual switching operation inconvenient, but also the user tends to forget to turn off the light signal device such that power consumption continues unnecessarily. Should that happen, the user probably will not know the light signal device is out of power until it is needed again to produce a warning light or turn signal, and the belated finding can be annoying.

If a bicycle is equipped with such a light signal device at the back as well as at the front, it is the rear one that is the more likely to be left turned on, or off. If the cyclist forgets to turn on the rear light signal device, he or she will be at risk when riding in a low-visibility environment (e.g., at night or in a tunnel). If the rear light signal device is left in the turned-on state due to the cyclist's negligence, it will keep consuming power, which is a wasteful use of energy and therefore environmentally unfriendly. Should the rear light signal device be out of power when needed, the cyclist will be in trouble.

It can be known from the above that a conventional light signal device must be switched on by hand in order to produce a warning light or turn signal. Such a design, however, is highly undesirable because of its inconvenience of use and the chances of inadvertent and unnecessary power consumption. It is an important issue for the related industry, therefore, to design a bicycle light signal device capable of automatic activation and a light signal system using the same, in which the bicycle light signal device is automatically turned on when the bicycle to which it is applied is running, and automatically turned off when the bicycle has stopped for longer than a predetermined period of time.

### BRIEF SUMMARY OF THE INVENTION

In view of the fact that the conventional light signal devices must be switched on and off manually, which not only is inconvenient, but also may lead to unnecessary power consumption of such devices if the users forget to turn them off after use, thus giving rise to those embarrassing moments when the devices are needed for service but turn out to be out of power, the inventor of the present invention incorporated years of practical experience in the related industry into designing, testing, and repeated adjustments and finally succeeded in developing a bicycle light signal device capable of automatic activation and a light signal system using the same, the goal being to solve the various drawbacks of the conventional light signal devices at once.

It is an objective of the present invention to provide a bicycle light signal device capable of automatic activation. The light signal device includes a housing, a power module, a vibration switch, a control module, a light signal module, and a switch. The housing is fixed to a bicycle and is provided therein with a receiving space. The power module is provided in the receiving space or is fixed to the bicycle. The vibration switch is electrically connected to the power module and the control module and can generate a vibration signal according to a vibration detection result. The control module is separately electrically connected to the power module and the vibration switch and can enter an operating state from a dormant state in response to the vibration signal or return to the dormant state if failing to receive the vibration signal for a predetermined period of time. The light signal module is electrically connected to the control module and can be driven by the control module to emit light when the control module is in the operating state. The switch is electrically connected to the control module. When the control module is in the operating state, switching the switch from a turned-off mode to any of various light-emitting modes will drive the switch to send a mode-switching signal to the control module, in order for the control module to control the light signal module according to the mode-switching signal so that the light signal module generates a corresponding light signal.

Another objective of the present invention is to provide a bicycle light signal system capable of automatic activation. The light signal system includes a first light signal device and a second light signal device. The first light signal device includes a first housing, a first power module, a first vibration switch, a first control module, a first light signal module, a switch, and a first transmission module. The first housing is fixed to a bicycle at a position adjacent to the front end of the bicycle and is provided therein with a first receiving space. The first power module is provided in the first receiving space or is fixed to the bicycle. The first vibration switch is electrically connected to the first power module and can generate a vibration signal. The first control module is separately electrically connected to the first power module and the first vibration switch. Once receiving the vibration signal from the first vibration switch, the first control module enters an operating state from a dormant state. If failing to receive the vibration signal for a predetermined period of time, the first control module returns from the operating state to the dormant state. The first light signal module is electrically connected to the first control module and can receive a signal of the first control module in order to be driven by the first control module to emit light. The switch is electrically connected to the first control module. When the first control module is in the operating state, switching the switch to a light-emitting mode will drive the first light signal module to generate a corresponding continuous or flashing light and will keep the first control module in the operating state. The first transmission module is electrically connected to the first control module so that, when the first control module receives a mode-switching signal, the first transmission module is driven by the first control module to transmit the mode-switching signal. The second light signal device includes a second housing, a second power module, a second vibration switch, a second control module, a second transmission module, and a second light signal module. The second housing is fixed to the bicycle at a position adjacent to the rear end of the bicycle and is provided therein with a second receiving space. The second power module is provided in the second receiving space or is fixed to the bicycle. The second vibration switch is electrically connected to the second power module and can generate a vibration signal when detecting a vibration. The second control module is provided in the second receiving space and is separately electrically connected to the second power module and the second vibration switch. Once receiving the vibration signal from the second vibration switch, the second control module enters an operating state from a dormant state. If failing to receive the vibration signal from the second vibration switch for a predetermined period of time, the second control module returns from the operating state to the dormant state. The second light signal module is electrically connected to the second control module and can receive a signal of the second control module in order to be driven by the second control module to emit light. The second transmission module is electrically connected to the second control module and can receive the mode-switching signal transmitted by the first transmission module in order for the second control module to stay in the operating state in response to the mode-switching signal and instruct the second light signal module to generate a continuous or flashing light corresponding to the mode-switching signal. Thus, when the user switches the switch of the first light signal device, the first and the second light signal devices are simultaneously controlled to generate the corresponding continuous or flashing light. When the user gets off the bicycle for a rest and leaves the bicycle immobile longer than the predetermined period of time, the first control module of the first light signal device and the second control module of the second light signal device automatically return to the dormant state. The light signal system therefore features simple operation and can effectively prevent a wasteful use of energy which may otherwise result from the user's forgetting to turn off the system power. Furthermore, as long as the switch remains in a light-emitting mode, it is ensured that the first and the second light signal devices will stay in the operating state and emit light as desired, even if the user is not moving the bicycle (e.g., when waiting for a red traffic light to turn green). Consequently, the user' personal safety in a night-time bicycle ride is effectively guaranteed.

### BRIEF DESCRIPTION OF THE SEVERAL VIEWS OF THE DRAWINGS

The objectives, as well as the technical features and their effects, of the present invention will be best understood by referring to the following detailed description of some illustrative embodiments in conjunction with the accompanying drawings, in which:

FIG. 1 is a block diagram showing the relationships between the various elements of the first preferred embodiment of the present invention;

FIG. 2 is a flowchart of the first preferred embodiment of the present invention; and

FIG. 3 is a block diagram showing the relationships between the various elements of the second preferred embodiment of the present invention.

### DETAILED DESCRIPTION OF THE INVENTION

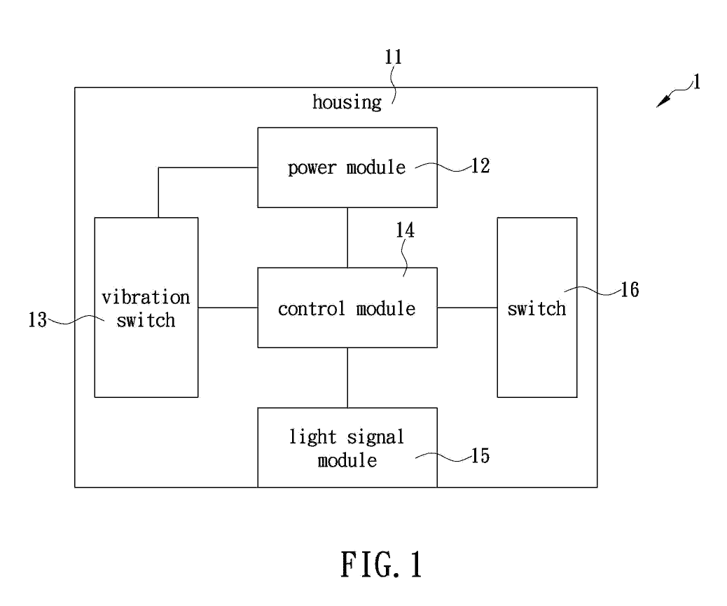

The first objective of the present invention is to provide a bicycle light signal device capable of automatic activation. Referring to FIG. 1 for the first preferred embodiment of the present invention, the light signal device 1 includes a housing 11, a power module 12 (e.g., a dry battery, rechargeable battery, or power-generating device), a vibration switch 13, a control module 14, a light signal (e.g., warning light or turn signal) module 15, and a switch 16. The housing 11 is configured to hold the rest of the aforementioned elements and be fixed to a bicycle (not shown). For example, the housing 11 can be fixed to the handles at the front end of the bicycle or to a frame member below the seat of the bicycle. In addition, the housing 11 is provided therein with a receiving space. In this preferred embodiment, one side of the housing 11 is made of a light-permeable material and therefore forms a light-permeable portion (not shown) through which light can pass from inside the housing 11 to the outside. The power module 12 is provided in the receiving space (in the case of a dry battery or rechargeable battery) or is fixed to the bicycle (in the case of an axle- or brake-driven power generating device or the like) in order to power the light signal device 1 with the electricity stored in or generated by the power module 12.

The vibration switch 13 is provided in the receiving space, is electrically connected to the power module 12, and is configured to detect vibrations continuously. When a vibration is detected (e.g., when the bicycle is moved or ridden), the vibration switch 13 generates a vibration signal to the control module 14. The control module 14 is provided in the receiving space, is separately electrically connected to the power module 12 and the vibration switch 13, and is configured to receive the vibration signal sent from the vibration switch 13. If the control module 14 receives the vibration signal while in a dormant state, the control module 14 enters an operating state from the dormant state. If staying in the operating state for a predetermined period of time (e.g., 60 seconds) without receiving the vibration signal (e.g., when the bicycle is left immobile), the control module 14 returns from the operating state to the dormant state. Therefore, when the bicycle starts being moved or ridden, the control module 14 receives the vibration signal from the vibration switch 13 and enters the operating state from the dormant state. Once the rider gets off the bicycle for a rest and leaves the bicycle immobile for longer than the predetermined period of time, the control module 14, which has failed to receive the vibration signal for the predetermined period of time, returns from the operating state to the dormant state.

As shown in FIG. 1, the light signal module 15 is provided in the receiving space and is electrically connected to the control module 14. The light signal module 15 does not produce light while the control module 14 is in the dormant state. When the control module 14 is in the operating state, however, the light signal module 15 can be driven by the control module 14 to produce light, which is projected out of the housing 11 through the light-permeable portion. The switch 16 is fixedly provided at the housing 11 and is electrically connected to the control module 14. While the control module 14 is in the operating state, the switch 16, if switched from a turned-off mode to one of various light-emitting modes (e.g., a continuous lighting mode or a flashing mode), will send a mode-switching signal to the control module 14, instructing the control module 14 to control the light signal module 15 according to the mode-switching signal so that the light signal module 15 generates a corresponding continuous light or flashing light. In this preferred embodiment, the control module 14 is kept in the operating state when the switch 16 is in any of the light-emitting modes (i.e., any mode other than the turned-off mode). This ensures that the light-emitting mode selected is effective.

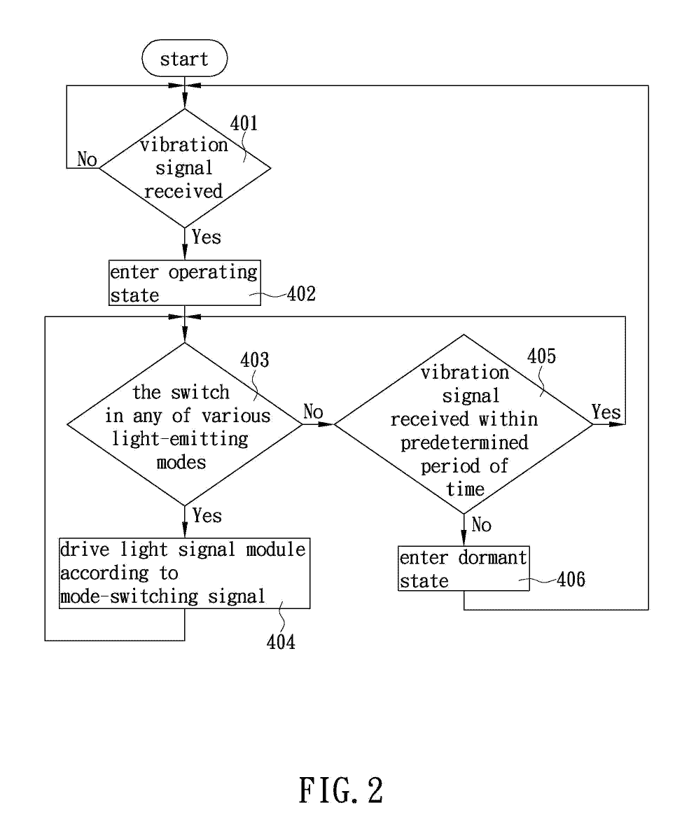

To specifically disclose the process flow of the operation of the bicycle light signal device capable of automatic activation, the major steps performed by the control module 14 are detailed below with reference to the flowchart in FIG. 2 and the reference numerals in FIG. 1:

(401) The control module 14 determines whether it has received the vibration signal. If yes, step (402) is executed; otherwise, step (401) is repeated.

(402) The control module 14 enters the operating state and performs step (403).

(403) The control module 14 determines whether the switch 16 is in any of various light-emitting modes. If yes, step (404) is executed; otherwise, step (405) is executed.

(404) The control module 14 drives the light signal module 15 to generate light according to the mode-switching signal of the switch 16. Then, step (403) is executed again.

(405) While the switch 16 is in the turned-off mode, the control module 14 determines whether it has received the vibration signal within a predetermined period of time. If yes, step (403) is executed again; otherwise, step (406) is executed.

(406) The control module 14 enters the dormant state and performs step (401).

In steps (403) and (405), if the bicycle rider, wishing to take a rest, has gotten off and parked the bicycle and turned off the switch 16, the control module 14 will, after the predetermined period of time elapses, return from the operating state to the dormant state in step (406) due to the fact that it has not received the vibration signal within the predetermined period of time. However, if the rider stops the bicycle only temporarily (e.g., waiting for a red traffic light to turn green) and does not turn off the switch 16, or if the rider moves the bicycle again before the expiration of the predetermined period of time, the control module 14 will remain in the operating state. As stated above, the control module 14 performs step (401) after returning to the dormant state due to persistent failure to receive the vibration signal. Only when the control module 14 once again receives the vibration signal will it reenter the operating state.

The bicycle light signal device capable of automatic activation is so designed that, when the user moves or begins to ride the bicycle, the vibration switch 13 is vibrated and hence automatically brings the control module 14 to the operating state.

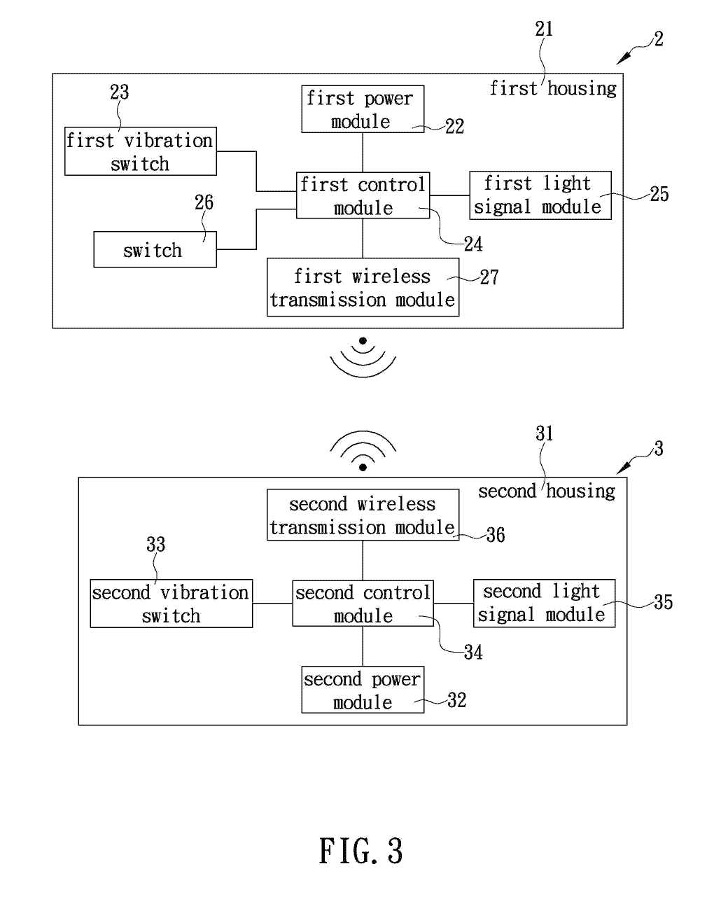

Referring now to FIG. 3, the second preferred embodiment of the present invention provides a bicycle light signal system capable of automatic activation, wherein the light signal system includes a first light signal device 2 and a second light signal device 3. The first light signal device 2 includes a first housing 21, a first power module 22, a first vibration switch 23, a first control module 24, a first light signal module 25, a switch 26, and a first wireless transmission module 27. The first housing 21 can be fixed to a bicycle at a position adjacent to the front end of the bicycle (e.g., fixed to the handles at the front end of the bicycle). Apart from that, the first housing 21, the first power module 22, the first vibration switch 23, the first control module 24, the first light signal module 25, and the switch 26 are similar in both function and arrangement to their counterparts in the first preferred embodiment and therefore will not be described repeatedly. The second light signal device 3 includes a second housing 31, a second power module 32, a second vibration switch 33, a second control module 34, a second light signal module 35, and a second wireless transmission module 36. The second housing 31 can be fixed to a bicycle at a position adjacent to the rear end of the bicycle (e.g., fixed to a frame member below the seat). Apart from that, the second housing 31, the second power module 32, the second vibration switch 33, the second control module 34, and the second light signal module 35 have substantially the same functions and arrangement as their counterparts in the first light signal device 2, except for the following.

In the second preferred embodiment, as stated above, the first and the second light signal devices 2 and 3 are provided with the first and the second vibration switches 23 and 33 respectively. When the user moves or begins to ride a bicycle to which the bicycle light signal system is applied, the first vibration switch 23 and the second vibration switch 33 generate their respective vibration signals and thereby drive the first control module 24 and the second control module 34 to enter the operating state from the dormant state respectively.

With continued reference to FIG. 3, the first and the second light signal devices 2 and 3 in the second preferred embodiment are respectively provided with the first and the second wireless transmission modules 27 and 36. The first wireless transmission module 27 is provided in the first receiving space, is electrically connected to the first control module 24, and is configured to transmit signals to and from the second wireless transmission module 36. Similarly, the second wireless transmission module 36 is provided in the second receiving space, is electrically connected to the second control module 34, and is configured to transmit signals to and from the first wireless transmission module 27. In this second preferred embodiment, if the user switches the switch 26 from a turned-off mode to one of various light-emitting modes while both the first and the second control modules 24 and 34 are in the operating state, the switch 26 will send a mode-switching signal to the first control module 24. As a result, the first control module 24 not only instructs the first light signal module 25 to generate a continuous or flashing light corresponding to the mode-switching signal, but also drives the first wireless transmission module 27 to transmit the mode-switching signal to the second wireless transmission module 36, in order for the second control module 34 to instruct the second light signal module 35 to generate the continuous or flashing light corresponding to the mode-switching signal. By the same token, when the user gets off the bicycle for a rest and switches the switch 26 to the turned-off mode, the first control module 24 responds to a turning-off signal from the switch 26 in such a way that, if failing to receive the vibration signal from the first vibration switch 23 within a predetermined period of time, the first control module 24 will return to the dormant state. The first control module 24 also drives the first wireless transmission module 27 to transmit the turning-off signal to the second wireless transmission module 36 in order for the second control module 34 to return to the dormant state in response to the turning-off signal if the second control module 34 fails to receive the vibration signal from the second vibration switch 33 within a predetermined period of time.

As mentioned previously, when both the front and rear ends of a bicycle are respectively provided with light signal devices, the rider tends to forget to turn on or off the light signal device at the rear end (i.e., the second light signal device 3 in the second preferred embodiment of the present invention, which is fixed to a frame member below the bicycle seat). If the bicycle light signal system capable of automatic activation is used, however, the first control module 24 of the first light signal device 2 and the second control module 34 of the second light signal device 3 will automatically enter the operating state when the user moves or starts to ride the bicycle to which the system is applied. Moreover, when the user switches the switch 26 of the first light signal device 2, which is mounted at the front end of the bicycle, the second light signal device 3 is simultaneously controlled to generate a corresponding continuous or flashing light. After the user gets off the bicycle for a rest and switches the switch 26 to the turned-off mode, the first control module 24 of the first light signal device 2 and the second control module 34 of the second light signal device 3 will automatically return to the dormant state if the bicycle is left immobile for longer than the predetermined period of time. Thus, operation of the light signal system is made simple, and a wasteful use of energy attributable to the user's forgetting to turn off the system power is effectively prevented. As is apparent from the foregoing process flow, when the switch 26 in the second preferred embodiment is in any of various light-emitting modes (i.e., not in the turned-off mode and not generating the turning-off signal), both the first control module 24 and the second control module 34 are kept in the operating state. Therefore, even if the user is not moving the bicycle (e.g., while waiting for a red traffic light to turn green), the second light signal device 3 will remain in the operating state and continue emitting light as long as the light signal device at the front end of the bicycle (i.e., the first light signal device 2, such as a headlight or a flashing warning light) is on. Consequently, the user's personal safety is effectively ensured in a night-time bicycle ride.

Referring again to FIG. 3, while the first light signal device 2 and the second light signal device 3 in the second preferred embodiment are respectively provided with the first wireless transmission module 27 and the second wireless transmission module 36 to enable signal transmission between the first and the second light signal devices 2 and 3 through the first and the second wireless transmission modules 27 and 36, it is feasible to form a wired connection between the first and the second light signal devices 2 and 3 in other embodiments of the present invention. In practice, the present invention is by no means limited to the embodiments described above, which serve only to illustrate a preferred mode of implementation.

While the invention herein disclosed has been described by means of specific embodiments, numerous modifications and variations could be made thereto by those skilled in the art without departing from the scope of the invention set forth in the claims.

What is claimed is:

1. A bicycle light signal device capable of automatic activation, comprising:
a housing fixed to a bicycle, wherein the housing is provided therein with a receiving space and has a side made of a light-permeable material and thus forming a light-permeable portion;
a power module provided in the receiving space or fixed to the bicycle;
a vibration switch provided in the receiving space and electrically connected to the power module, wherein the vibration switch generates a vibration signal upon detecting a vibration;
a control module provided in the receiving space and separately electrically connected to the power module and the vibration switch, wherein the control module enters an operating state from a dormant state upon receiving the vibration signal from the vibration switch or returns from the operating state to the dormant state if failing to receive the vibration signal for a predetermined period of time;
a light signal module provided in the receiving space and electrically connected to the control module, wherein the light signal module receives a signal of the control module and is thus driven by the control module to emit light; and
a switch fixedly provided at the housing and electrically connected to the control module, wherein when the control module is in the operating state, the switch sends a mode-switching signal to the control module upon being switched to a light-emitting mode, in order for the control module to stay in the operating state and instruct the light signal module to emit light according to the mode-switching signal, thereby ensuring effectiveness of the light-emitting mode.

2. The bicycle light signal device of claim 1, wherein the switch sends a turning-off signal to the control module upon being switched to a turned-off mode, in order for the control module to turn off the light signal module according to the turning-off signal and also start timing according to the turning-off signal so that, if failing to receive the vibration signal from the vibration switch for the predetermined period of time, the control module returns to the dormant state.

3. The bicycle light signal device of claim 1, wherein the light-emitting mode of the switch at least includes a continuous lighting mode and a flashing mode; when the switch is switched to the continuous lighting mode, the light signal module is driven to emit light continuously; and when the switch is switched to the flashing mode, the light signal module is driven to flash.

4. The bicycle light signal device of claim 2, wherein the light-emitting mode of the switch at least includes a continuous lighting mode and a flashing mode; when the switch is switched to the continuous lighting mode, the light signal module is driven to emit light continuously; and when the switch is switched to the flashing mode, the light signal module is driven to flash.

5. A bicycle light signal system capable of automatic activation, comprising:
a first light signal device comprising:
a first housing fixed to a bicycle at a position adjacent to a front end of the bicycle, wherein the first housing is provided therein with a first receiving space and has a side made of a light-permeable material and thus forming a first light-permeable portion;
a first power module provided in the first receiving space or fixed to the bicycle;
a first vibration switch provided in the first receiving space and electrically connected to the first power module, wherein the first vibration switch generates a first vibration signal upon detecting a vibration;
a first control module provided in the first receiving space and separately electrically connected to the first power module and the first vibration switch, wherein the first control module enters an operating state from a dormant state upon receiving the first vibration signal from the first vibration switch or returns from the operating state to the dormant state if failing to receive the first vibration signal for a predetermined period of time;
a first light signal module provided in the first receiving space and electrically connected to the first control module, wherein the first light signal module receives a signal of the first control module and is thus driven by the first control module to emit light;
a switch fixedly provided at the first housing and electrically connected to the first control module, wherein when the first control module is in the operating state, the switch sends a mode-switching signal to the first control module upon being switched to a light-emitting mode, in order for the first control module to stay in the operating state and instruct the first light signal module to emit light according to the mode-switching signal, thereby ensuring effectiveness of the light-emitting mode; and
a first transmission module provided in the first receiving space and electrically connected to the first control module, wherein when the first control module receives the mode-switching signal, the first transmission module is driven by the first control module to transmit the mode-switching signal; and
a second light signal device comprising:
a second housing fixed to the bicycle at a position adjacent to a rear end of the bicycle, wherein the second housing is provided therein with a second receiving space and has a side made of a light-permeable material and thus forming a second light-permeable portion;
a second power module provided in the second receiving space or fixed to the bicycle;
a second vibration switch provided in the second receiving space and electrically connected to the second power module, wherein the second vibration switch generates a second vibration signal upon detecting a vibration;
a second control module provided in the second receiving space and separately electrically connected to the second power module and the second vibration switch, wherein the second control module enters an operating state from a dormant state upon receiving the second vibration signal from the second vibration switch or returns from the operating state to the dormant state if failing to receive the second vibration signal for a predetermined period of time;
a second light signal module provided in the second receiving space and electrically connected to the second control module, wherein the second light signal module receives a signal of the second control module and is thus driven by the second control module to emit light; and
a second transmission module provided in the second receiving space, electrically connected to the second control module, and configured for receiving signal from the first transmission module so as to receive the mode-switching signal transmitted by the first transmission module and send the mode-switching signal to the second control module, in order for the second control module to stay in the operating state and instruct the second light signal module to emit light according to the mode-switching signal, thereby ensuring effectiveness of the light-emitting mode.

6. The bicycle light signal system of claim 5, wherein the switch sends a turning-off signal to the first control module upon being switched to a turned-off mode, in order for the first control module to turn off the first light signal module according to the turning-off signal and also start timing according to the turning-off signal so that, if failing to receive the first vibration signal from the first vibration switch for a predetermined period of time, the first control module returns from the operating state to the dormant state, wherein the first control module also sends the turning-off signal to the first transmission module in order for the first transmission module to send the turning-off signal to the second control module through the second transmission module such that, upon receiving the turning-off signal, the second control module turns off the second light signal module according to the turning-off signal, starts timing according to the turning-off signal, and, if failing to receive the second vibration signal from the second vibration switch for the predetermined period of time, returns to the dormant state.

7. The bicycle light signal system of claim 5, wherein the first transmission module and the second transmission module are wireless transmission modules.

8. The bicycle light signal system of claim 6, wherein the first transmission module and the second transmission module are wireless transmission modules.

9. The bicycle light signal system of claim 7, wherein the light-emitting mode of the switch at least includes a continuous lighting mode and a flashing mode; when the switch is switched to the continuous lighting mode, the first light signal module and the second light signal module are driven to emit light continuously; and when the switch is switched to the flashing mode, the first light signal module and the second light signal module are driven to flash.

10. The bicycle light signal system of claim 8, wherein the light-emitting mode of the switch at least includes a continuous lighting mode and a flashing mode; when the switch is switched to the continuous lighting mode, the first light signal module and the second light signal module are driven to emit light continuously; and when the switch is switched to the flashing mode, the first light signal module and the second light signal module are driven to flash.
